(19) United States
(12) Patent Application Publication
(10) Pub. No.: US 2002/0169620 A1
(43) Pub. Date: Nov. 14, 2002

(54) Method of doing business: customer-driven design of a charge storage device

(76) Inventors: Robert M. Spotnitz, Pleasanton, CA (US); John W. Van Zee, Columbia, SC (US)

Correspondence Address: SUMMA & ALLAN, P.A., 11610 NORTH COMMUNITY HOUSE ROAD, SUITE 200, CHARLOTTE, NC, 28277, US

(21) Appl. No.: 09/821,553

(22) Filed: Mar. 29, 2001

(51) Int. Cl. G06F 17/60

(52) U.S. Cl. 705/1

(57) ABSTRACT

The instant invention is directed to a method for customer-driven design of a charge storage device. The method comprises the steps of: providing more than one model of a charge storage device, the model adapted to convert at least one input to at least one output; and providing an interface, the interface being adapted to pass input from the customer to the model, the interface being adapted to pass output from the model to the customer, and the interface being adapted to hide the model from the customer. In operation, the customer addresses the interface with input. The interface directs the input to at least one of the models. The model generates an output that is passed through the interface to the customer.

### FIELD OF THE INVENTION

The instant invention is directed to a method of doing business, specifically for the customer-driven design of a charge storage device.

### BACKGROUND OF THE INVENTION

A charge storage device (CSD) includes, but is not limited to, batteries (primary and secondary), fuel cells, capacitors, supercapacitors, and the like. In essence, charge storage devices are a means of powering electronic or electrically operated machines or devices. Electronic or electrically operated machines or devices include, but are not limited to, laptop computers, cellular phones, pagers, power tools, military communications equipment, and the like. Demand for charge storage devices is being created, primarily, by the rapid innovation in the electronics industry. These new devices and machines require compact and portable energy sources, i.e., a charge storage device.

Referring to FIGS. 1 and 2, two methods of doing business are illustrated. These figures illustrate how a customer for a charge storage device could interact with the manufacturer of a charge storage device. To facilitate the discussion, the customer for the CSD will be, for example, a manufacturer of a personal digital assistant (PDA) and the manufacturer of the CSD will be, for example, a battery manufacturer; it being understood that the instant invention is not so limited.

Referring to FIG. 1, there is illustrated a direct interaction model 10 where customer 12 needs a custom designed battery for their new PDA. Customer 12 selects at least two battery manufacturers 14, 14′ from whom it shall solicit bids for the new battery. Since discussions with each of the battery manufacturers is essentially the same, only one will be discussed in detail, it being understood that like numerals indicate like function. Customer 12 would initially consult a sales and/or technical sales representative 16 of the battery manufacturer 14. These discussions are often cloaked under confidentiality agreements because of the need to protect the technical assets (or technology) of both customer 12 and manufacturers 14, 14′. During these discussions, customer 12 would divulge the requirement of their new battery. Salesman/technical representative 16 would gather this information, and share it with the engineering department 18 of battery manufacturer 14. Typically, after several iterations between the engineering department 18, technical sales representative 16, and customer 12, a new battery will have been developed. Of course, it is possible that during the foregoing discussions that work on customer's 12 new battery may be terminated by battery manufacturer 14 for any number of technical or economical reasons. After, the engineering department 18 and the customer 12 have arrived upon a design for the new battery, it is sent to the manufacturing department 20 of manufacturer 14 where it is again considered as a possible candidate for manufacture. Once again, several iterations between manufacturing department 20, engineering department 18, representatives 16, and customer 12 are probable. Finally, after the manufacturing department's 20 review, the sales department 22 of manufacturer reviews the new battery for pricing and volume considerations. This process can be extremely time consuming and frustrating to customer 12 who is interested in rapidly introducing his new product, the PDA, into the market and risky for customer 12 because manufacturer 14 can drop out of the discussions at any time, thereby limiting customer 12's options for sourcing the new battery.

Referring to FIG. 2, there is illustrated an indirect interaction method 30 where customer 12 hires a consultant 32 to interface with the battery manufacturers 14, 14′. Customer 12 hires a consultant 32 and divulges its battery needs to the consultant 32. The consultant 32, in turn, interfaces directly with the battery manufacturers 14 and 14′. Customer 12's hope is that the use of consultant 32 will facilitate interaction with the battery manufacturers 14, 14′ and thereby, reduce time and cost and increase the probability of obtaining the new battery. Consultant 32, because of their unique knowledge of both the battery and the battery manufacturers 14, 14′, can have a beneficial impact upon the end result desired by the customer 12. This scenario, however, does not always render the desired result.

It is known to use mathematical models to stimulate the behavior of real world systems. These models may be empirically derived models, or first principle models (FPM), or combinations of both.

An empirically derived model of a charge storage device is illustrated in U.S. Pat. No. 6,160,382. The '382 patent discloses a method for matching a charge storage device (e.g., a battery) to a circuit model (e.g., devices such as a DC motor, or cellular phone) by using an impedance measurement, and a method of characterizing the CSD by impedance measurement. The operational characteristics (e.g., capacity, average discharge voltage, discharge voltage profile, internal resistance, temperature behavior, charge cutoff voltage, and the like) of a battery (e.g., alkaline, lead/acid, Ni/Cd, lithium ion, lithium polymer, and the like) differ. For example, a lead/acid battery has different characteristics than a lithium ion battery. These differences will, most likely, render one battery more suitable for use, practical and economical, with one device than another device (e.g., a lead/acid battery is not used to power a cellular phone).

A first principle model is illustrated in U.S. Pat. No. 6,016,047. The '047 patent discloses a battery management system (BMS) and a battery simulator. The battery management system may, among other things, monitor the current discharge of the battery and, based upon a model of the battery's performance, calculate the battery's state of charge (SOC). The model, or first principle model (FPM), is based upon the physical and chemical reactions and mechanisms in operation of the main electrochemical storage reaction (see column 11, line 1-column 25, line 13). This simulator can be used to develop new batteries, select batteries for a specific product, and design a battery management system for a specific type of battery (see column 25, line 14-column 26, line 4).

One battery manufacturer has provided software for sizing batteries to customers. The sizing program allows the customer to input their battery requirements, and get, in return, the manufacturer's recommendation about the possible batteries offered by that manufacturer which would meet the customer requirements. See “WinSize” (www.saftware.com), a product provided by Saft (a division of Alcatel Inc.). This sizing program automates the IEEE recommended practice (Std 1115-2000) for sizing nickel-cadmium batteries for stationary applications. Essentially, the program provides a means for selecting cells made by Saft, and does not provide a means for developing custom cell designs.

Varta (www.varta.com) offers a much less sophisticated web-based program for selecting batteries for particular applications. The user selects a particular device and the software reports which Varta product is suitable for that application.

Additionally, one company offers design services which utilize computer assisted design techniques. For example, see Design Automation Associates, Inc. (www.daasolutions.com). While this is a viable alternative, its limitations are that the design information contained in their program are not tailored to the particular manufacturer, and accordingly, after obtaining a design, it is still necessary to consult the manufacturer and re-enter the process, as illustrated in FIG. 2.

Accordingly, there is a need for a method of doing business in which there is provided a customer-driven method to design a charge storage device.

### SUMMARY OF THE INVENTION

The instant invention is directed to a method for customer-driven design of a charge storage device. The method comprises the steps of: providing more than one model of a charge storage device, the model adapted to convert at least one input to at least one output; and providing an interface, the interface being adapted to pass input from the customer to the model, the interface being adapted to pass output from the model to the customer, and the interface being adapted to hide the model from the customer. In operation, the customer addresses the interface with input. The interface directs the input to at least one of the models. The model generates an output that is passed through the interface to the customer.

The instant invention is, also, directed to a method for customer-driven charge storage device design, where the method comprises the steps of: providing a customer interface adapted for defining a customer test procedure for a desired charge storage device and defining a customer requirement for the charge storage device; providing a plurality of charge storage device models; providing a routine capable of selecting at least one of the charge storage device models; executing a simulation wherein the customer test procedure, the customer requirement, and the selected charge storage device model are combined to render a custom charge storage device design; storing the custom charge storage device design; and outputting the custom charge storage device design.

### DESCRIPTION OF THE DRAWINGS

For the purpose of illustrating the invention, there is shown in the drawings a form which is presently preferred; it being understood, however, that this invention is not limited to the precise arrangement and instrumentalities shown.

FIG. 1 is a schematic illustration of direct interaction between a customer and manufacturer on a new product design.

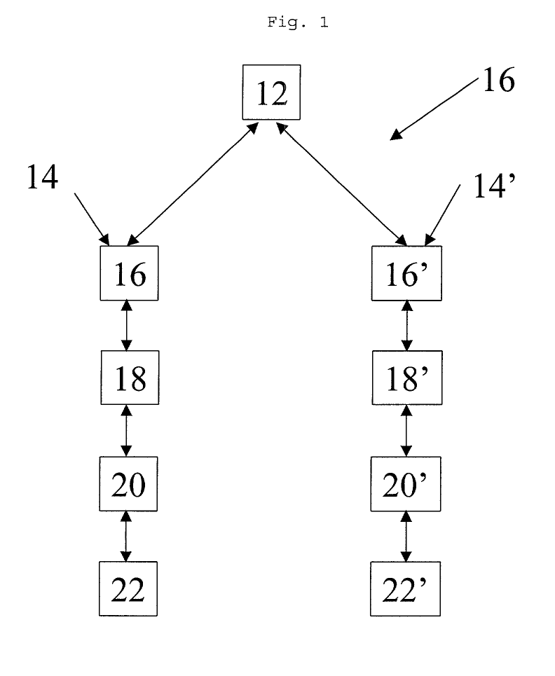

FIG. 2 is a schematic illustration of indirect interaction, interaction facilitated by a consultant, between a customer and manufacturer on a new product design.

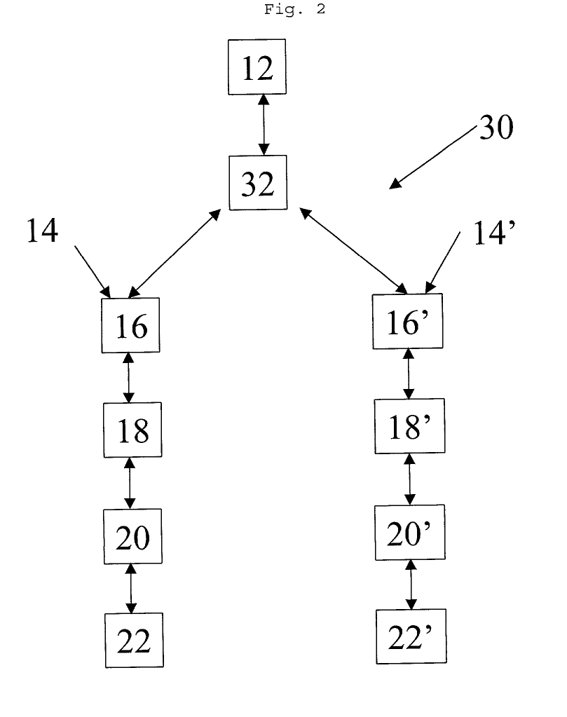

FIG. 3 is a schematic illustration of the instant invention, the interaction between customer and manufacturer being through a computer interface.

FIG. 4 is a schematic illustration of one embodiment of the instant invention.

### DESCRIPTION OF THE INVENTION

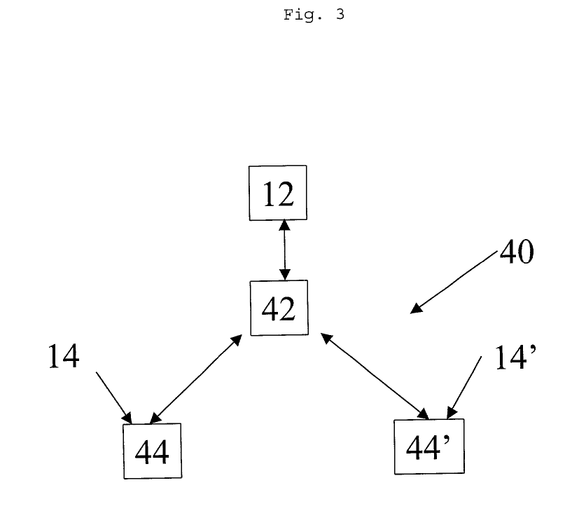

Referring to the drawings, wherein like numerals indicate like elements, there is shown, in FIG. 3, a method of doing business 40, specifically, a method for customer-driven design of a charge storage device. In method 40, customer 12 has access, via an interface 42, to models 44 and 44′, which are the proprietary property of manufacturers 14 and 14′. It is contemplated that interface 42 is available on the internet and that models 44 and 44′ may be located with the interface or be accessible through the interface. Alternatively, interface 42 and models 44 may be provided by another data transfer medium, e.g., compact disk (CD) or flash memory card. By this, the interface and models would be loaded on the customer's computer. The models, however, would have to be protected from customer hacking (or cracking).

Interface 42 is the means through which the customer 12 communicates with models 44, 44′ and the means through which the models communicate with customer 12. Additionally, interface 42 prevents customer 12 from having direct access to the models 44, 44′ so that the proprietary information of the manufacturer is protected. Moreover, the manufacturer will not have access to customer's requirements. These functions are imperative, so that customer and manufacturer are able to maintain control over their proprietary information. The interface 42, preferably, includes an optimization/regression program that assists in the design. Interface 42 is preferably a graphical user interface (GUI).

Models 44, 44′ may be empirically derived models (see for example, U.S. Pat. No. 6,016,047 incorporated herein by reference), first principle models (see for example, U.S. Pat. No. 6,160,382), or combinations of both. Preferably, the model is a first principles' model that has been customized by the manufacturer to the specific materials used by the manufacturer. The first principle models would have to be customized to a particular manufacturer by access to a database of materials available to that manufacturer. The FPM mathematically expresses the chemical and physical interactions of the charge storage device. One such FPM is based upon the Nernst equation

G^{o}=−nFE^{o}

where

G^{o}=standard free energy

F=Faraday's constant

E^{o}=standard electromotive force.

For a given cell

aA+bB=cC+dD

the Nernst equation may be expressed as

$$E = {E}^{o} - \frac{RT}{n F} ln \frac{{a}_{C}^{c} {a}_{D}^{d}}{{a}_{A}^{a} {a}_{B}^{b}}$$

where

aᵢ=activity of relevant species

R=gas constant

T=absolute temperature.

See: Linden, D. Ed., Handbook of Batteries, 2^{nd} ed., McGraw-Hill, Inc., New York City, N.Y. (1995), incorporated herein by reference. In this model, the activities, aᵢ, would have to be specified for a given cell. This information could be stored in a database which would be accessed by the model. Thus, several different batteries, e.g., batteries with different chemistries or different materials, could be simulated.

More detailed models have been described in the literature for specific battery systems. The following articles are incorporated herein by reference:

For lithium ion cells, T. F. Fuller, M. Doyle and J. Newman have presented a first principles' model (J. Electrochem. Soc. Vol. 141, No. 1, January 1994 pp. 1-10). The authors later used that model to accurately predict discharge performance of commercially available lithium-ion cells manufactured by Sony Corporation (J. Electrochem. Soc. Vol. 141, No. 4, January 1994 pp. 982-990).

W. B. Gu, C. Y. Wang and B. Y. Liaw have shown that first principles' models can be used to simulate the behavior of electric vehicle (EV) batteries (J. Power Sources 75 (1998) 151-161). They showed that battery performance under standard driving profiles could be simulated for both lead acid and nickel metal hydride EV batteries.

H. A. Catherino, J. F. Burgel, A. Rusek, and F. Feres (J. Power Sources 80 (1999) 17-20) developed an empirical model for lead acid batteries used for starting/lighting/ignition (SLI). They showed that the model could be used to simulate charging behavior.

J. N. Harb and R. M. LaFollette (J. Electrochem. Soc. 146 (3) 809-818 (1999)) developed a first principles' model for spirally-wound lead-acid batteries and showed that the model could be used to simulate current-voltage-time behavior.

M. Jain, G. Nagasubramanian, R. G. Jungst, and J. W. Weidner (J. Electrochem. Soc. 146 (11) 4023-4030 (1999)) developed a first principles' model for a lithium/thionyl chloride primary battery. They showed that the model could accurately simulate discharge behavior of the battery over a wide range of temperatures and discharge loads.

Z. Mao and R. E. White developed a first principles' model for a primary zinc/air battery (J. Electrochem. Soc. Vol. 139, No. 4, April 1992 pp. 1105-1114). They showed that the discharge voltage could be simulated.

T. W. Farrell, C. P. Please, D. L. S. McElwain, and D. A. J. Swinkels (J. Electrochem. Soc. 147 (11) 4034-4044 (2000) developed a first principles' model for an alkaline battery. They showed that the discharge behavior of various alkaline cell sizes could be simulated.

C. Lin, J. A. Ritter, B. N. Popov, and R. E. White (J. Electrochem. Soc., Vol. 146, no. 9, 1999, p. 3168) present a first principles' model for capacitors.

Numerous other references for mathematically representing the behavior of batteries, capacitors, and fuel cells can be found in the scientific literature. The feasibility of mathematically representing the performance behavior of charge storage devices is well established.

Accordingly, it is contemplated that each one of the designs could differ from manufacturer to manufacturer because of different models and materials used by each.

In operation, customer 12 would “go to” or address interface 42 and input a parameter. Interface 42 would then take that input and pass it to one or more of the models 44 or 44′. The model would take the customer input and generate an output. The output would then be returned to interface 42 where it would be displayed to customer 12. output would most likely be the specifications (or design) of a charge storage device that has been customized by the model based upon the customer input.

Exemplary customer inputs could be, but are not limited to, energy density, cycle life, rate capability, impedance, temperature range of operation and/or survival, safety requirements, storage life, self-discharge behavior, form factor, and cost. Each customer input could be accompanied by a weighting factor to indicate the importance of the requirement.

Exemplary outputs could be, but are not limited to, energy density, cycle life, rate capability, impedance, temperature range of operation and/or survival, safety requirements, storage life, self-discharge behavior, form factor, cost for a specific design. At a minimum, the outputs reflect the customer input requirements, but the values refer to a specific design that could be produced by a manufacturer.

The underlying model 44 or 44′ will require inputs from the battery (or, more generally, charge storage device) manufacturer. Exemplary manufacturer inputs could be, but are not limited to, electrode formulations, electrolyte formulations, separator type, package dimensions, a list of cell internals, etc.

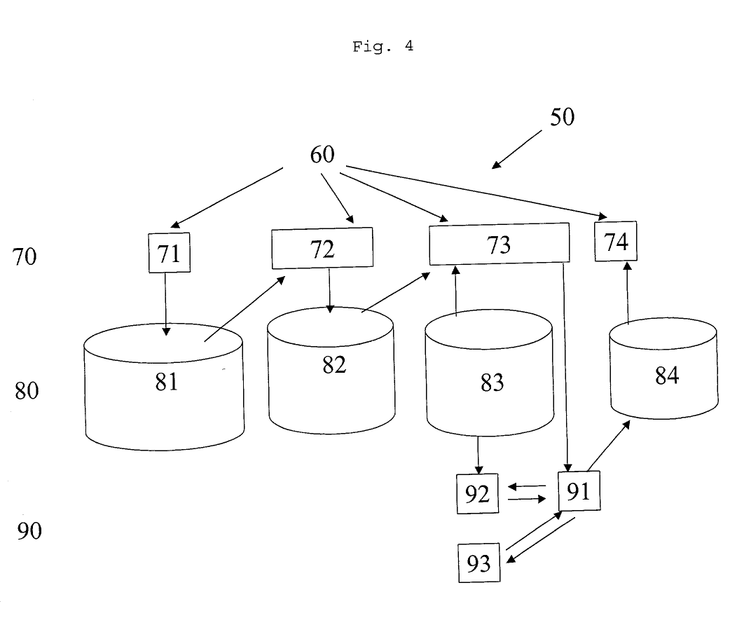

FIG. 4 shows a diagram for how a customer-driven charge storage device system 50 could be constructed. The system consists of user interfaces 70, databases 80, and routines 90. The design of the system can best be appreciated by consideration of how it is typically used. The following steps are involved:

1. The user 60 defines a set of test procedures through a user interface 71. The user interface 71 is connected to a database 81 for storing details of the test procedure. For example, the user might define a “Cycle Life Test” for a battery that involves repetition of the following steps until the discharge capacity is 80% of the 2^{nd} cycle discharge capacity:

a. discharging the battery at a current of 1 Ampere to a cutoff voltage of 3 V,

b. letting the battery rest for 15 minutes,

c. then charging the battery at 1 Ampere to a cutoff voltage of 4.2 V and

d. holding at 4.2 V so that the total charge time is two hours.

The user interface for defining test procedures 71 should allow a variety of tests (such as rate, cycle life, storage) to be defined as well as abuse tests (such as short circuit and overcharge). The user interfaces are preferably designed so as to mimic test equipment used to characterize charge storage devices. For example, the same interface used for a programmable battery cycler (such as the “M-R Software” sold by MACCOR Inc.) could be used to define the test performance test programs.

2. The user then defines a set of requirements based upon the previously defined test procedures using user interface 72. For example, the user might require that the battery go at least 500 cycles in the “Cycle Life Test”. Along with the requirements the user can specify objectives. For example, the user might specify that one objective is to minimize the cost of the battery. If the user specifies more than one objective, then each objective can be given a weighting factor. For example, the user might specify the objectives of minimizing cost with a weight factor of 1 and minimizing volume with a weight factor of 10. This objective would then be to find a battery design that minimize the function, 1·Cost+10·Volume.

3. The user then selects, through user interface 73, the cell design (e.g., the cell model) from a particular battery manufacturer, the requirements, and executes the simulation. Executing the simulation first involves a call to a control routine 91.

4. The control routine 91 uses some technique to find a cell design that satisfies the objective function defined by the user; if no objective function has been defined by the user, then the control routine would simply carry out the tests specified by the user. If an optimization is required, the optimization technique might be as simple as trying a fixed number of cell designs, or as complex as a successive quadratic programming technique. In either case the control routine will first call a sizing program 92 to determine the physical dimensions. The physical dimensions are then passed to a simulation model 93 that is capable of predicting cell performance. For any given battery there is normally several simulation models. For example, there is a simulation model for predicting cycle life behavior, a simulation model for predicting self-discharge behavior, a simulation model for predicting short-circuit behavior, a simulation model for predicting overcharge behavior, etc. The sizing routines and simulation routines are preferably developed in a language (e.g., COM or CORBA) that facilitates communication between the programs (and provides language independence). Once the control routine is finished, the results are stored in a database 84.

5.The user can view the results from an optimization through a user interface 74 that can generate reports. For example, the user could obtain a plot of cell capacity versus cycle number.

With the above construction, consider a simple example. A user wants to find a Ni/Cd cell with the highest initial voltage. Two battery manufacturers make Ni/Cd cells and both use the Nernst equation to predict the cell voltage of their batteries. However, battery manufacturer A can make Ni/Cd cells with an initial water activity ranging from 0.9 to 0.8, while manufacturer B can make Ni/Cd cells with an initial water activity ranging from 0.8 to 0.75. According to the Nernst equation, the cell voltage of a Ni/Cd is given by

$$E = {E}_{o} + \frac{RT}{F} ln \frac{{a}_{Cd} {a}_{NiOOH}^{2} {a}_{{H}_{2} O}^{2}}{{a}_{{Cd ( OH )}_{2}} {a}_{{Ni ( OH )}_{2}}^{2}}$$

Since the activity of solid materials can be set to unity, this equation simplifies to

$$E = {E}_{o} + \frac{RT}{F} ln {a}_{{H}_{2} O}^{2}$$

The higher the activity of water, the higher the initial cell voltage will be.

According to FIG. 4, the user could define a test using interface 71 called “ZERO CURRENT VOLTAGE” that involves measuring the cell voltage with zero current. Then the user could define an objective using interface 72 of maximizing the ZERO CURRENT VOLTAGE. Using interface 73, the user could select Manufacturer A and run a simulation. The control routine might be programmed to just examine the highest and lowest value of the water activity. If so, the control routine would determine that the optimum cell voltage was Eo+(RT/F)ln(0.9²) and write this value to the results database 84. The user could access this value through user interface 74. The user could then repeat the above steps except select Manufacturer B and find the optimum cell voltage was Eo+(RT/F)ln(0.8²). Thus, the user would select manufacturer A to provide a cell with high initial voltage. Although the user can find that manufacturer A has the capability to provide higher voltage Ni/Cd cells than manufacturer B, the user has no access to the underlying mechanism that the manufacturers are varying water concentration.

The customer-driven charge storage device system is preferably designed so that the details of the manufacturer's cell are confidential. One way this can be accomplished is for the manufacturer to supply the cell sizing 92 and simulation 93 routines as compiled programs. The control routine can call the cell sizing routine to determine how many parameters are adjustable and the ranges of those parameters, but the control routine would not have access to the physical significance of those parameters. In this case, the manufacturer's cell database 83 would contain details of the calling protocols of the sizing and simulation routines.

The present invention may be embodied in other specific forms without department from the spirit or central attributes thereof, and, accordingly, reference should be made to the appended claims, rather than to the foregoing specification, as indicating the scope of the invention.

That which is claimed:

1. A method for customer driven charge storage device design comprising the steps of:
providing more than one model of a charge storage device, the model adapted to convert at least one input into at least one output;
providing an interface, the interface being adapted to pass input to the model, the interface being adapted to pass output from the model, and the interface being adapted to hide the model;
wherein the customer addresses the interface with the input, the interface directs the input to at least one of the models, the model generates the output that passes through the interface to the customer.

2. The method of claim 1 wherein the model is selected from the group consisting of first principles' models, empirically-based models, and hybrid models consisting of combinations of first principles' models and empirically-based models.

3. The method of claim 1 wherein the input further comprised a plurality of inputs.

4. The method of claim 1 wherein the output further comprises a plurality of outputs.

5. The method of claim 1 wherein the model further comprises a database, the model and the database being in communication.

6. The method of claim 1 wherein the output further comprises a design of the charge storage device.

7. A method for customer-driven charge storage device design comprising the steps of:
providing a customer interface adapted for defining customer test procedure for a desired charge storage device and defining customer requirement for the charge storage device;
providing a plurality of charge storage device models;
providing a routine capable of selecting at least one of the charge storage device models;
executing a simulation wherein the customer test procedure, the customer requirement, and the selected charge storage device model are combined to render a custom charge storage device design;
storing the custom charge storage device design; and
outputting the custom charge storage device design.

8. The method of claim 7 wherein the selecting routine being adapted for either customer selction of routine selection based upon, at least in part, the customer test procedure and the customer requirement.

9. The method of claim 7 wherein the model further comprises a sizing program and a performance program.

10. The method of claim 7 wherein the model further comprises a sizing program and a performance and an abuse program.

11. The method of claim 7 wherein executing a simulation further comprises the step of optimizing the simulation.

12. The method of claim 7 wherein outputting the custom charge storage device design further comprises the step of reporting the design.
